(19) United States
(12) Patent Application Publication
(10) Pub. No.: US 2011/0320974 A1
(43) Pub. Date: Dec. 29, 2011

(54) METHOD AND SYSTEM HAVING A VIRTUAL KEYBOARD ON DEVICES WITH SIZE LIMITED TOUCH SCREEN

(76) Inventors: Kun Bai, Elmsford, NY (US); Zhiguo Gao, Beijing (CN); Leslie Shihua Liu, White Plains, NY (US); James Randal Moulic, Poughkeepsie, NY (US); Dennis G. Shea, Ridgefield, NY (US)

(21) Appl. No.: 12/825,773

(22) Filed: Jun. 29, 2010

(51) Int. Cl. G06F 3/048; G06F 3/02

(52) U.S. Cl. 715/773; 345/168; 345/173; 455/566

(57) ABSTRACT

A method for providing and using a touch screen to enter letters or symbols which form a desired word entry input to a smart mobile device includes a touch screen display configured to display one of a plurality of regions of a replicated standard keyboard display. Key buttons are displayed in the one of the plurality of regions to provide a key button size substantially similar to at least half the size of an average human finger.

### BACKGROUND

1. Technical Field

The present disclosure relates to hand-held mobile communication devices, and, more particularly, to touch screen keyboards for smart hand-held mobile communication devices.

2. Discussion of Related Art

In recent years smart mobile devices have become more and more popular for enterprise and consumer applications. For example, there is an emerging trend to use smart mobile phones in place of desktop computers.

Many leading technology companies have released various smart mobile devices. These smart mobile devices typically have the capability to notify users of events through either audio or vibration.

A significant challenge for these smart mobile devices is to be “user friendly”. A key aspect of a user friendly device lies in its user interface and input system. For example, when using a conventional personal computer (PC), information can be input to the PC through a keyboard which has physical keys which suit the user's fingers. On the other hand, conventional input systems of mobile devices are problematic in their lack of ability to provide ease of input of information to the mobile device such that message communication with others using the mobile device is facilitated with minimum input errors.

Typically, there are two kinds of keyboards in conventional smart mobile devices. One is the soft-keyboard displayed on a touch screen. The other is the hard-keyboard with physical keys that are depressed. Both the soft-keyboard and the hard-keyboard have drawbacks in that the keyboards are too small to be effectively used by human fingers, and if a touch pen is needed to access the keys of the keyboard, it becomes impossible to use with one hand.

Some smart mobile devices have a hard-keyboard large enough such that a user can type using only one hand. However, the screen size becomes small to accommodate the larger size of the hard keyboard or such mobile devices tend to be larger than the conventional smart mobile devices using soft-keyboards.

Some smart mobile devices having a soft-keyboard can invoke a specific soft-keyboard on a touch screen in a context aware manner. For example, when a telephone application is invoked, the soft key-board automatically becomes a number keypad or when an email application is invoked, and a user needs to input an email address, specific symbols normally used in email, such as “@”, “.com”, and the like, will appear in the keypad.

However, while emerging trends in smart mobile devices are to have them small in size, user input errors become quite common because of the small key button size whether in devices having soft-keyboards and hard-keyboards.

Referring to FIG. 1, for example, there is shown a conventional smart mobile device 10 having a touch-screen keyboard 12. The touch-screen keyboard 12 has key buttons 14, each key button indicating one of 26 letters of the English alphabet. A typical key button size may be ⅛″ by 3/16″ and have narrow 1/32″ gaps between adjacent key buttons. Such key button size and gaps provide difficulty for a typical ½″ diameter human finger to precisely hit a desired key button without interacting with one or more adjacent or undesired key buttons.

As such, providing a smart mobile device with a keyboard such that words can be input using only one hand, that have relatively large key buttons to reduce input errors, that enable blindly typing with relatively low errors, and that associate various touch-feelings for different key buttons, has become a desirable device.

### BRIEF SUMMARY

In accordance with exemplary embodiments of the present disclosure, an input system for smart mobile devices is provided which combines the benefits of soft-keyboards and hard-keyboards and allows for typing and input using only one hand with relatively low input errors.

In accordance with an exemplary embodiment, a method for providing a touch screen to enter letters or symbols which form a desired entry input to a smart mobile device includes configuring a touch screen display to display one of a plurality of regions of a replicated standard keyboard display, and sizing key buttons displayed in the one of the plurality of regions to provide a key button size substantially similar to at least half the size of an average human finger.

The method may further include spacing adjacent displayed key buttons by at least 1/16″.

The one of the plurality of regions may be a left half of the replicated standard keyboard display and an other of the plurality of regions may be a right half of the replicated keyboard display.

The method may further include generating a ring-tone or vibration when a display of one of the plurality of regions is changed to an other one of the plurality of regions.

The method may further include generating a ring-tone or vibration to indicate a position of a key button in a region.

In accordance with an exemplary embodiment a method of using a touch screen to enter letters or symbols which form a desired entry input to a smart mobile device includes configuring a touch screen display to display one of a plurality of regions of a replicated standard keyboard display, sizing key buttons displayed in the one of the plurality of regions to provide a key button size substantially similar to at least half the size of an average human finger, and pressing a key button of the touch screen display to enter a letter or symbol.

The method may further include pressing a key button for a predetermined amount of time to confirm an entry input.

The method may further include double-clicking a key button to confirm an entry input.

The method may further include canceling an entry input if a user does not provide an entry confirmation.

According to an exemplary embodiment, a non-transitory computer program storage device embodying instructions executable by a processor to perform entry of letters or symbols that form a desired word being input to a smart mobile device using a touch screen is provided. Instruction code is included for configuring the touch screen display to display one of a plurality of regions of a replicated standard keyboard display. Instruction code is included for sizing key buttons displayed in one of the plurality of regions to provide a key button size substantially similar to at least half the size of an average human finger. Instruction code is included for entry of a letter or symbol by pressing a key button of the touch screen.

The non-transitory computer program storage device may further include instruction code for spacing apart adjacent displayed key buttons by at least 1/16″.

The non-transitory computer program storage device may include instruction code for providing for the one of the plurality of regions being a left half of a replicated keyboard display and an other of the plurality of regions being a right half of a replicated keyboard display.

The non-transitory computer program storage device may further include instruction code for generating a ring-tone or vibration when a display of one of the plurality of regions is changed to an other one of the plurality of regions.

The non-transitory computer program storage device may further include instruction code for generating a ring-tone or vibration to indicate a position of a key button in a region.

The non-transitory computer program storage device may further include instruction code for confirming an entry input upon a pressing of a key button for a predetermined amount of time.

The non-transitory computer program storage device may further include instruction code for confirming an entry input upon a double-clicking of a key button.

The non-transitory computer program storage device may further include instruction code for canceling an entry input if a user does not provide an entry confirmation.

### BRIEF DESCRIPTION OF THE SEVERAL VIEWS OF THE DRAWINGS

Exemplary embodiments of the present disclosure will be more clearly understood from the following detailed description taken in conjunction with the accompanying drawings in which:

FIG. 1 depicts a conventional smart mobile device with a soft-keyboard touch screen;

FIGS. 2A and 2B depict an exemplary embodiment of the present disclosure having a soft-keyboard divided into two regions; and

FIG. 3 provides a sequence of operational steps in accordance with an exemplary embodiment.

FIGS. 4A, 4B, 4C and 4D depict implementation steps for an exemplary embodiment of the present disclosure having a feedback-based input with confirmation.

### DETAILED DESCRIPTION

Reference will now be made in detail to the exemplary embodiments, examples of which are illustrated in the accompanying drawings, wherein like reference numerals refer to the like elements throughout.

In accordance with exemplary embodiments, the present inventive concept provides for splitting the standard keyboard layout into several regions. At a particular time frame of typing, only one part of the keyboard may be shown on the touch screen, with dramatically increased key button size. In an exemplary embodiment, the standard keyboard may be divided into two regions, namely left and right regions of the standard keyboard. Those skilled in the art would appreciate that the regions may be divided into various other configurations, for example, four regions (2 by 2, namely, two regions in a row and two regions in a column).

In accordance with exemplary embodiments, the present inventive concept may also provide users with an easy-to-remember notification by region based vibrations or ring-tones when changing the regions shown on the touch screen.

In accordance with exemplary embodiments, the present inventive concept may provide users notifications of the key positions in one particular region by position-based vibrations or ring-tones.

Referring now to FIGS. 2A and 2B, an exemplary embodiment of the present disclosure is depicted.

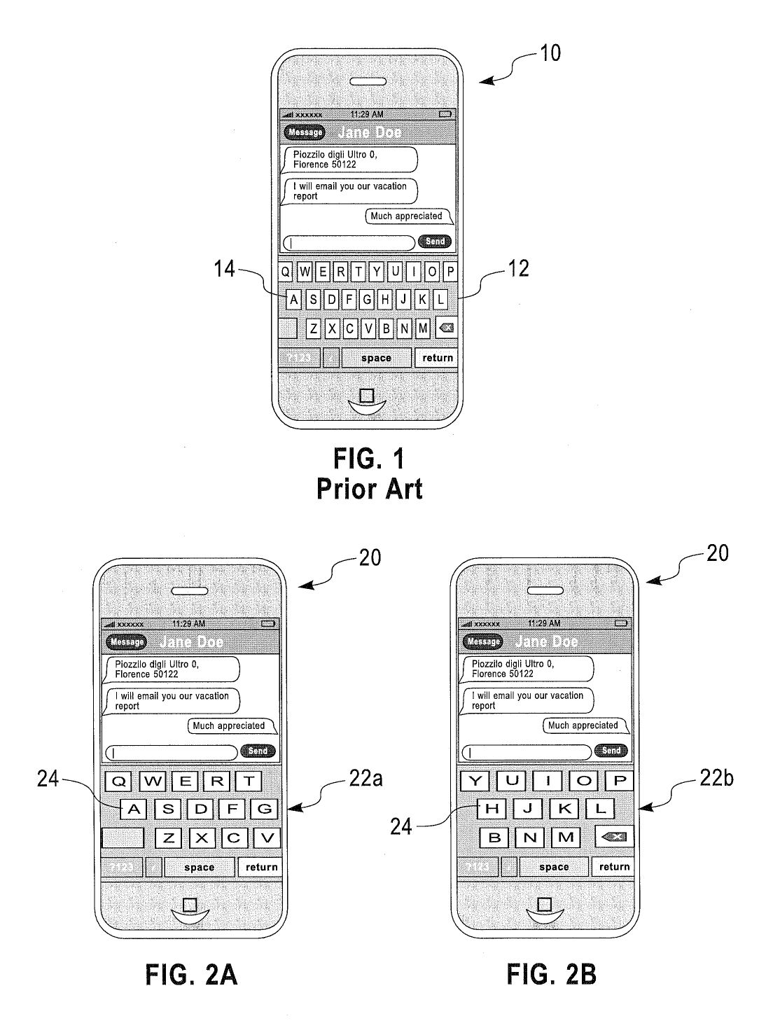

Smart mobile device 20 includes a soft-keyboard which provides for one of two keyboard regions, region 22a (seen in FIG. 2A) and region 22b (seen in FIG. 2B), to be separately displayed as desired by the user. Soft key buttons 24 have an approximate ¼″ by ¼″ size and have approximate 1/16″ gaps between adjacent key buttons. Such soft key button size and gaps, as compared to the soft key buttons 14 of the conventional smart mobile device shown in FIG. 1, do not provide difficulty for a typical ½″ diameter human finger to precisely hit a desired key button without interacting with one or more adjacent or undesired soft key buttons. By splitting the traditional soft-keyboard into regions to fit small touch screens helps to enhance the user's input effectiveness. In an exemplary embodiment an alphabetical soft keyboard would be divided into two regions, each of the soft key regions containing a number of soft keys. A numerical soft key region could contain 0-9 soft keys. To switch from one region to another, the user would tap on the left/right corner of the screen bottom. In an exemplary embodiment software instruction code of a soft keyboard control module would decide how many soft key regions are needed to accommodate an entire input alphabet and which soft key region would each key be assigned to. When a user interacts with an input interface, the soft keyboard control module interprets the inputs based upon the display virtual key(s) touched by the user and generates the event for which the key (or keys) were inputted by the user. These input events would be used by other software instruction code in other software modules (such as the MIDI ring-tone module) to provide feedback to the user. At the same time, the inputs would also be passed on to the mobile communication device's software operating system for processing by the software operating system's instruction code.

Each touch screen region may be given a ring-tone or vibration associated with the respective region, such that when a letter is typed in one region that ring-tone or vibration associated with the one region is effectuated. In an exemplary embodiment a unique Musical Instrument Digital Interface (MIDI) sound (e.g., a ring tone) may be associated with tapping a left/right corner when switching the region forwards or backwards. In an exemplary embodiment software instruction code of a MIDI (ring tone) keyboard module would play a MIDI audio based upon the input received from the soft keyboard control module. The MIDI audio used for feedback can be unique among its own region only, or unique to the entire alphabet. The association of MIDI audio to each soft key can be done automatically or specified by the user. The MIDI ring tone module would record such association and use an audio player to generate the MIDI feedback when a soft key is received by the soft key control module.

Each touch screen soft key button may also be given a unique touch feeling to help users recall their experience of using a hard-keyboard and thus maintain a consistent user experience. In an exemplary embodiment for each region on top of a current screen, when a soft key is tapped, the unique MIDI sound can be played. The same unique sound may be used for different soft key regions.

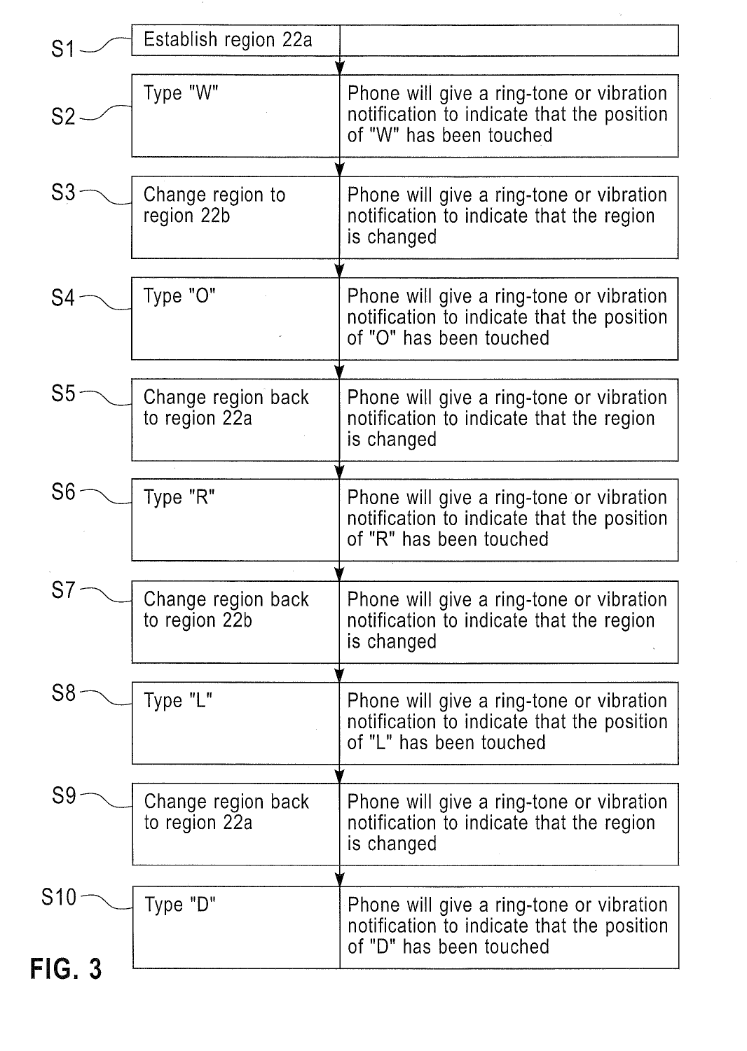

Referring to FIGS. 2A, 2B and 3, an operational example in accordance with an exemplary embodiment is provided. For example, consider that an input of the word “World” is desired. In step S1 region 22a is established as the soft-keyboard by using an alphabetical soft keyboard divided into three regions, with each of the soft key regions containing a number of soft keys. Two letter soft key regions could contain 13 letters each, i.e., half of the English alphabet letters. To switch from one letter region to another letter region, the user would tap on the left/right corner of the screen bottom. A numerical soft key region could also be provided which contains numerals 0-9 soft keys. In step S2 the letter “W” is touched on the keyboard 24 and the phone will give a ring-tone or vibration notification to indicate that the position of “W” has been touched. In step S3 the user changes the region to region 22b and the phone will give a ring-tone or vibration notification to indicate that the region is changed. In step S4, the letter “O” is touched on the keyboard 24 and the phone will give a ring-tone or vibration notification to indicate that the position of “O” has been touched. In step S5, the region is changed back to region 22a and the phone will give a ring-tone or vibration notification to indicate that the region is changed. In step S6 the letter “R” is touched and the phone will give a ring-tone or vibration notification to indicate that the position of “R” has been touched. In step S7 the region is changed to region 22b and the phone will give a ring-tone or vibration notification to indicate that the region is changed. In step S8, the letter “L” is touched and the phone will give a ring-tone or vibration notification to indicate that the position of “L” has been touched. In step S9 the region is changed back to region 22a and the phone will give a ring-tone or vibration notification to indicate that the region is changed. In step S10 the letter “D” is typed and the phone will give a ring-tone or vibration notification to indicate that the position of “L” has been touched.

In accordance with an exemplary embodiment, a feedback-based input (i.e., “input-without-looking” may also include providing a unique feedback when a key is pressed before an input is confirmed. If the pressed key is what the user intended, he/she can confirm the input by either keeping pressing the displayed key button for a certain amount of time or double-clicking the displayed key button. Another unique feedback could be provided when the key input is confirmed. The input could be canceled if the user doesn't confirm it.

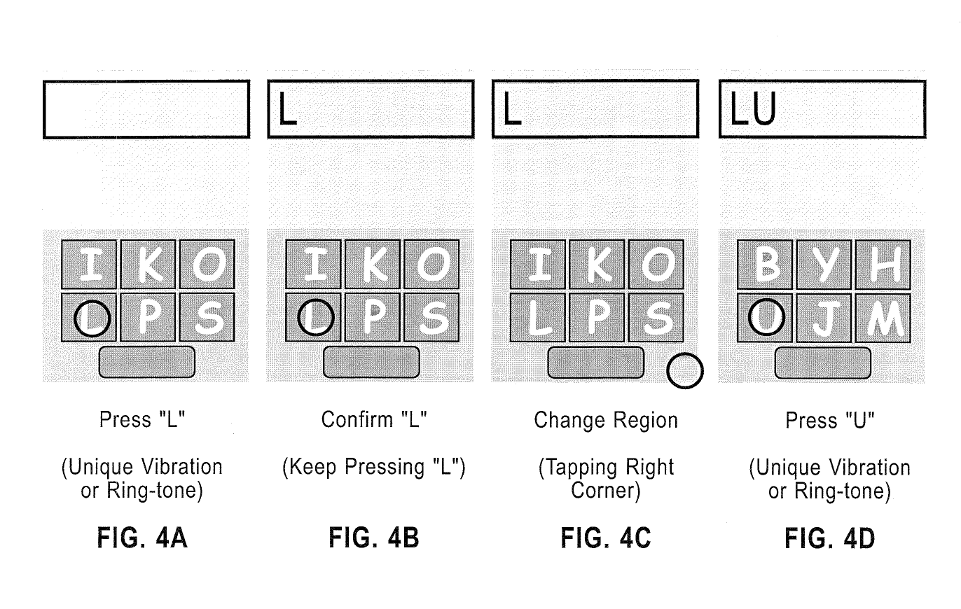

Referring to FIGS. 4A-4D, an implementation of the feedback-based input with confirmation is depicted. Consider the entry of the letters “LU” into a touch screen entry box. In FIG. 4A, a letter “L” would be pressed and a unique vibration or ring-tone would be produced. In FIG. 4B, with the letter “L” appearing in the touch screen entry box, the soft-key L would be kept pressed to confirm the “L” entry. To enter the letter “U”, the region displayed would need to be changed. To do so, the right corner of the screen would be tapped, as shown by the circle depicted in FIG. 4C. In FIG. 4D a new region would appear and the soft-key “U” would be pressed and a unique vibration or ring-tone would be produced. A letter confirmation would then be undertaken (not shown).

Those skilled in the art will appreciate that the present inventive concept may be implemented by conventional touch screen hardware and software that provide for the display of soft-keyboards on touch screens and that provide for ring tone and/or vibration notifications upon touching specific soft-key buttons of the soft-keyboard(s), for example, by using Microsoft Corporation's Dynamic Soft Keyboard, whose implementation details may be seen in U.S. patent application Ser. No. 12/025,721 filed on Feb. 4, 2008, the entire content of which is incorporated by reference herein. The dynamic soft keyboard discussed in such patent application addresses the soft keyboard from one or more aspects. A user input may be received via a soft keyboard which includes multiple keys. A key describing a current input environment for the soft keyboard is obtained, and a determination is made by the predictive engine as to which one or more keys of the multiple keys was intended to be selected by the user input. Thus, a group of chosen keys is displayed on the soft keyboard dynamically as the user inputs.

While exemplary embodiments have been particularly shown and described, it will be understood that various changes in form and details may be made therein without departing from the spirit and scope of the following claims.

1. A method for providing a touch screen to enter letters or symbols which form a desired entry input to a smart mobile device, comprising:
configuring a touch screen display to display one of a plurality of regions of a replicated standard keyboard display; and
sizing key buttons displayed in the one of the plurality of regions to provide a key button size substantially similar to at least half the size of an average human finger.

2. The method of claim 1, further comprising spacing adjacent displayed key buttons by at least 1/16″.

3. The method of claim 1, wherein the one of the plurality of regions is a left half of the replicated standard keyboard display and an other of the plurality of regions is a right half of the replicated keyboard display.

4. The method of claim 1, further comprising generating a ring-tone or vibration when a display of one of the plurality of regions is changed to an other one of the plurality of regions.

5. The method of claim 1, further comprising generating a ring-tone or vibration to indicate a position of a key button in a region.

6. A method of using a touch screen to enter letters or symbols which form a desired entry input to a smart mobile device, comprising:
configuring a touch screen display to display one of a plurality of regions of a replicated standard keyboard display;
sizing key buttons displayed in the one of the plurality of regions to provide a key button size substantially similar to at least half the size of an average human finger; and
pressing a key button of the touch screen display to enter a letter or symbol.

7. The method of claim 6, further comprising spacing adjacent displayed key buttons by at least 1/16″.

8. The method of claim 6, wherein the one of the plurality of regions is a left half of the replicated standard keyboard display and an other of the plurality of regions is a right half of the replicated keyboard display.

9. The method of claim 6, further comprising generating a ring-tone or vibration when a display of one of the plurality of regions is changed to an other one of the plurality of regions.

10. The method of claim 6, further comprising generating a ring-tone or vibration to indicate a position of a key button in a region.

11. The method of claim 6, further comprising pressing a key button for a predetermined amount of time to confirm an entry input.

12. The method of claim 6, further comprising double-clicking a key button to confirm an entry input.

13. The method of claim 6, further comprising canceling an entry input if a user does not provide an entry confirmation.

14. A non-transitory computer program storage device embodying instructions executable by a processor to perform entry of letters or symbols that form a desired word being input to a smart mobile device using a touch screen, comprising:
instruction code for configuring the touch screen display to display one of a plurality of regions of a replicated standard keyboard display;
instruction code for sizing key buttons displayed in one of the plurality of regions to provide a key button size substantially similar to at least half the size of an average human finger; and
instruction code for entry of a letter or symbol by pressing a key button of the touch screen.

15. The non-transitory computer program storage device of claim 14, further comprising instruction code for spacing apart adjacent displayed key buttons by at least 1/16″.

16. The non-transitory computer program storage device of claim 14, wherein the one of the plurality of regions is a left half of a replicated keyboard display and an other of the plurality of regions is a right half of a replicated keyboard display.

17. The non-transitory computer program storage device of claim 14, further comprising instruction code for generating a ring-tone or vibration when a display of one of the plurality of regions is changed to an other one of the plurality of regions.

18. The non-transitory computer program storage device of claim 14, further comprising instruction code for generating a ring-tone or vibration to indicate a position of a key button in a region.

19. The non-transitory computer program storage device of claim 14, further comprising instruction code for confirming an entry input upon a pressing of a key button for a predetermined amount of time.

20. The non-transitory computer program storage device of claim 14, further comprising instruction code for confirming an entry input upon a double-clicking of a key button.

21. The non-transitory computer program storage device of claim 14, further comprising instruction code for canceling an entry input if a user does not provide an entry confirmation.
